(19) United States
(12) Patent Application Publication
(10) Pub. No.: US 2008/0075477 A1
(43) Pub. Date: Mar. 27, 2008

(54) Methods for Moving A Media Sheet Within An Image Forming Device

(76) Inventors: Edward Lawrence Kiely, Lexington, KY (US); William Paul Cook, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/533,802

(22) Filed: Sep. 21, 2006

(51) Int. Cl. G03G 15/00

(52) U.S. Cl. 399/16

(57) ABSTRACT

The present application is directed to methods for moving a media sheet along a media path of an image forming device. The media path may include first and second sections. A sensor that detects the media sheet moving along the media path may be positioned between the first and second sections. The media sheet moves through the first section and past the sensor causing the sensor to send a signal to a controller. The media sheet may be moved at differing speeds past the sensor causing the sensor to be activated when the sheet is moving at a first speed, and deactivated when the media sheet is moving at a second speed. The controller may adjust the speed of one or both of the first and second sections based on the signal or signals received from the sensor.

### BACKGROUND

The present application is directed to methods of moving a media sheet through an image forming device and, more particularly, to moving the media sheet past one or more sensors along the media path and adjusting the speed based on the position and orientation of the media sheet

The media sheet moves along a media path that extends through the image forming device. The media path includes a toner transfer area where toner images are transferred to the media sheets. The media sheet with toner images is then either outputted from the device for simplex printing on a single sides or moved through a duplex path for printing on a second side.

A controller may oversee the movement of the media sheet along the media path. The controller may carefully control the speed of the media sheet to ensure adequate print quality. One area where the speed is carefully controlled is the toner transfer area where the media sheet should move within a specific speed range. If the media sheet moves too quickly or slowly through this area, the toner images are not adequately transferred to the media sheet which may result in a print defect.

The media sheet may move at different speeds along different sections of the media path. The media sheet may move through a first section at a first slower speed, and a second section at a second, faster speed. The controller should track the movement of the media sheet and ensure the required speed requirements are maintained. The timing of speed adjustments may become complicated when the sections are in proximity to each other along the media path. The controller should maintain the required speed through each section without upsetting the movement of the media sheet through the adjacent section.

### SUMMARY

The present application is directed to methods for moving a media sheet along a media path of an image forming device. The media path includes a first section and a second downstream section. A sensor is positioned between the first and second sections to detect the media sheet after it passes through the first section and moves towards the second section. A speed of the second section may be adjusted to move the media sheet through the section at either a first speed or a second faster speed. When the second section is driven at the first speed the media sheet may form a slackened area that activates the sensor. When the second section is driven at the second speed, the slackened area in the media sheet may be removed thereby deactivating the sensor. A controller adjusts the speed of the second section based on one or more signals received from the sensor.

### BRIEF DESCRIPTION OF THE DRAWINGS

FIG. 1 is schematic side view of an image forming device according to one embodiment.

FIG. 2 is schematic view of a controller within an image forming device according to one embodiment.

FIGS. 3-7 are schematic views of a media sheet moving along a media path according to one embodiment.

FIG. 8 is a schematic view of a media path within an image forming device according to one embodiment

### DETAILED DESCRIPTION

The present application is directed to methods of moving a media sheet within an image forming device. A media path extends through the device for moving the media sheets to receive a toner image. One or more sensors are positioned along the media path to detect the position of the media sheets and signal a controller that oversees the media sheet movement. The speed of the media sheet may be varied to ensure the media sheet moves along the media path at a proper speed to ensure adequate image formation. The sensor may be activated when the media sheet moves at a first speed, and deactivated when the media sheet moves at a second speed. The controller receives a signal from the sensor indicating the orientation of the media sheet. The controller may adjust the speed of one or more sections of the media path based on these signal or signals.

The image forming device 10 may include a laser printer (mono or color), facsimile, copier, or combination of two or more of these devices which is often referred to as an all-in-one device. The device 10 may be sized to fit on a workspace, such as a desktop. The device 10 may further include accessible work areas for the user to insert and remove media sheets, replace components within the device, and clear media jams from within the device.

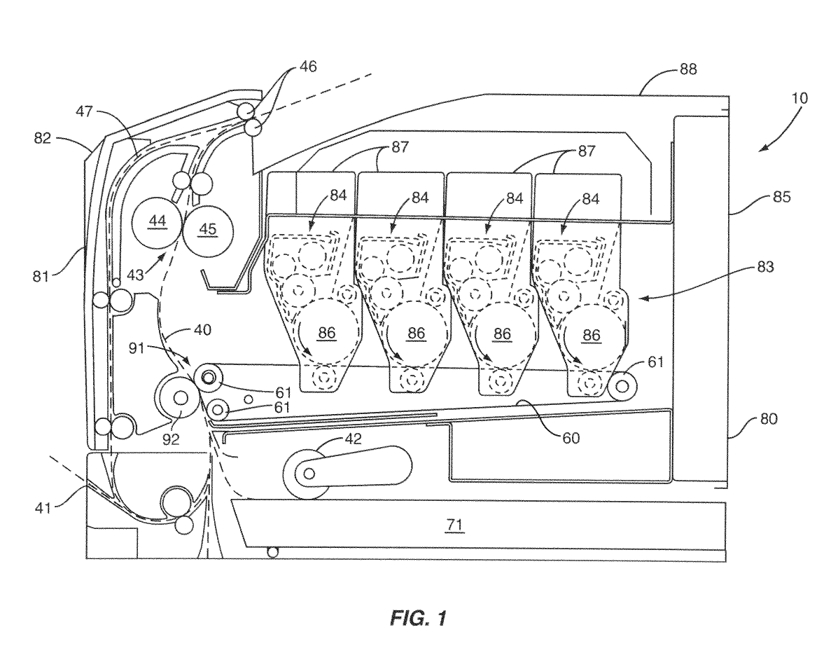

FIG. 1 illustrates one embodiment of an image forming device 10. The device 10 includes a media input tray 71 positioned in a lower section of a body 80. The tray 71 is sized to contain a stack of media sheets that will receive color and/or monochrome images. The media input tray 71 is preferably removable for refilling Therefore, in this embodiment, a user may insert and remove the media input tray 71 from the device 10 through a front 81 of the body 80. A control panel 82 may be located on the front 81 of the body 80. Using the control panel 82, the user is able to enter commands and generally control the operation of the image-forming device 10. For example, the user may enter commands to switch modes (e.g., color mode, monochrome mode), view the number of images printed, take the device 10 on/off line to perform periodic maintenance, and the like.

A first toner transfer area 83 includes one or more imaging units 84 that are aligned horizontally extending from the front 81 to a back 85 of the body 80. Each imaging unit 84 includes a charging roll, a developer roll, and a rotating photoconductive (PC) drum 86. The charging roll forms a nip with the PC drum 86, and charges the surface of the PC drum 86 to a specified voltage such as −1000 volts, for example. A laser beam from a printhead contacts the surface of the PC drum 86 and discharges those areas it contacts to form a latent image. In one embodiment, areas on the PC drum 86 illuminated by the laser beam are discharged to approximately −300 volts. The developer roll, which also forms a nip with the PC drum 86, then transfers toner particles from a toner reservoir 87 to the PC drum 86 to form a toner image. The toner particles are attracted to the areas of the PC drum 86 surface discharged by the laser beam. In one embodiment, the toner reservoirs 87 each contain one of black, magenta, cyan, or yellow toner.

An intermediate transfer mechanism (ITM) 60 is disposed adjacent to each of the imaging units 84. In this embodiment, the ITM 60 is formed as an endless belt trained about support rollers 61. The ITM 60 may be constructed from a variety of materials including polyimide, Ethylene TetrafluoroEthylene (ETFE), nylon, thermoplastic elastomers (TPE), polyamide-imid, and polycarbonate alloy. During image forming operations, the ITM 60 moves past the imaging units 84 in a clockwise direction as viewed in FIG. 1. One or more of the PC drums 86 apply toner images in their respective colors to the ITM 60. In one embodiment, a positive voltage field attracts the toner image from the PC drums 86 to the surface of the moving ITM 60.

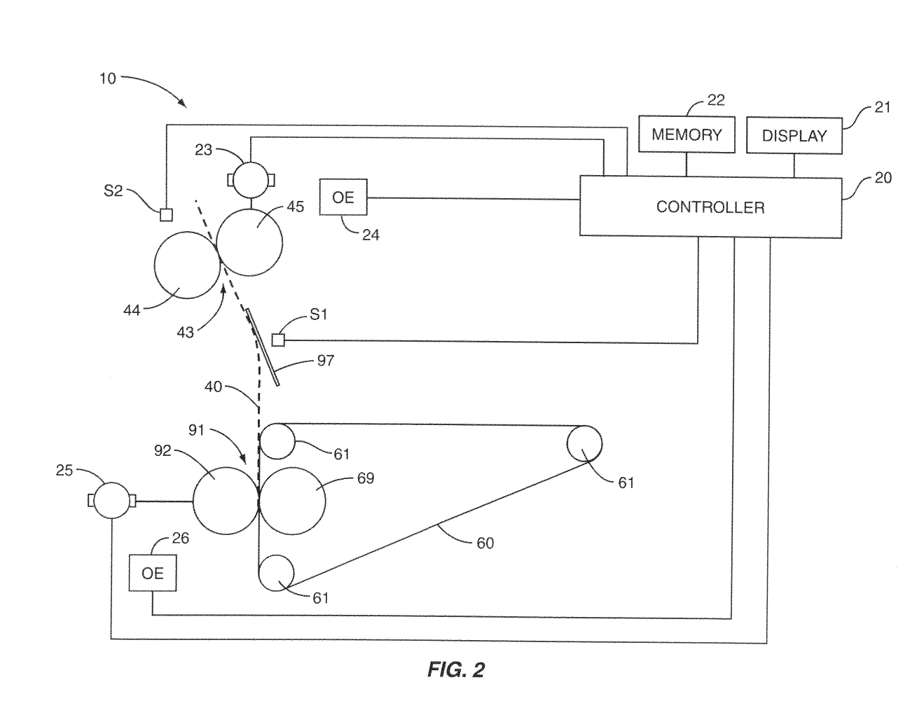

The ITM 60 rotates and collects the one or more toner images from the imaging units 84 and then conveys the toner images to a media sheet at a second transfer area. The second transfer area includes a second transfer nip 91 formed between one of the rollers 61 and a second transfer roller 92. In other embodiments as illustrated in FIG. 2, the second transfer nip 91 is formed between roller 92 and a separate back-up roller 69.

A media path 40 extends through the device 10 for moving the media sheets. Media sheets are initially stored in the input tray 71 or introduced into the body 80 through a manual feed 41. The sheets in the input tray 71 are picked by a pick mechanism 42 and moved into the media path 40. In this embodiment, the pick mechanism 42 includes a roller positioned at the end of a pivoting arm. The roller rotates to move the media sheets from input tray 71 towards the second transfer area. In one embodiment, the pick mechanism 42 is positioned in proximity (i.e., less than a length of a media sheet) to the second transfer area with the pick mechanism 42 moving the media sheets directly from the input tray 71 into the second transfer nip 91. For sheets entering through the manual feed 41, one or more rollers are positioned to move the sheet into the second transfer nip 91.

The media sheet receives the toner image from the ITM 60 as it moves through the second transfer nip 91. The sheets with toner images then move along the media path 40 and into a fuser nip 43. Fuser nip 43 is formed between a pair of rollers or belts 44, 45 that apply heat and pressure to adhere the toner images to the media sheet The fused media sheets then pass through exit rollers 46 that are located downstream from the fuser nip 43. Exit rollers 46 may be rotated in either forward or reverse directions. In a forward direction, the exit rollers 46 move the media sheet from the media path 40 to an output area. In a reverse direction, the exit rollers 46 move the media sheet into a duplex path 47 for image formation on a second side of the media sheet.

The second transfer nip 91 and fuser nip 43 also each function to move the media sheet along sections of the media path 40. Therefore, the speeds of the nips 91, 43 are controlled to maintain the proper speed to ensure toner transfer at the second transfer nip 91 and adequate fusing at the fuser nip 43. The speed of the media sheet as it moves along the media path 40 may vary. By way of example, a first speed may be necessary for moving the media sheet through the second transfer nip 91, and a second faster or slower speed is necessary for moving through the fuser nip 43. In one embodiment, the distance between the nips 91, 43 is less than the length of the media sheet. Therefore, the media sheet is in contact with both nips 91, 43 at the same time. The speed of the nips 91, 43 should be carefully controlled to ensure the media sheet moves at the required speed through each section without affecting the speed of the sheet as it moves through the other section.

FIG. 2 illustrates a schematic view of the device 10 that includes a controller 20. Controller 20 oversees the timing and movement of the toner images and the media sheets. In one embodiment as illustrated in FIG. 2, controller 20 includes a microprocessor with associated memory 22. In one embodiment, controller 20 includes a microprocessor, random access memory read only memory, and an input/output interface. A display 21 may further be operatively connected to the controller 20 for displaying messages to an operator. The display 21 may include an LED or LCD array to display alpha-numeric characters.

Sensors S1, S2, are placed along the media path 40 to determine the position and orientation of the media sheet. In one embodiment, one or both sensors S1, S2 include an actuator arm positioned within the media path 40. Movement of the media sheet along the media path 40 causes the actuator arm to be pushed aside which either actuates a switch, or is sensed by an emitter/receiver combination as described below. In another embodiment, one or both sensors S1, S2 are optical sensors that detect a leading edge or trailing edge of the media sheet when passing the sensor location. The sensors S1 and/or S2 include an emitter that transmits a signal and a receiver that receives the signal. The signal is interrupted when the media sheet passes past the sensor thus indicating the location. One embodiment of a sensor includes a light-emitting diode as the emitter and a phototransistor as the receiver.

In one embodiment, a first sensor S1 is placed on the media path 40 between the second transfer nip 91 and the fuser area 43, and second sensor S2 is positioned downstream from the fuser area 43. The sensors S1, S2 may be the same, or may be different. Additional sensors may be placed along the media path 40 as necessary. Each sensor S1, S2 is operatively connected to the controller 20 and provides the controller 20 with information regarding the media sheets

Controller 20 may further be operatively connected to an encoder 26 and a motor 25 that drives one or both rollers 92, 69 at the second transfer nip 91. Encoder 26 is operatively connected to the controller 20 and ascertains the revolutions and rotational position of the motor 25. Each revolution of the motor 25 equates to a predetermined amount of movement of the media sheet through the second transfer area 91. Controller 20 may also be operatively connected to motor 23 and encoder 24 at the fuser area 43. Motor 23 drives one or both members 44, 45 as the media sheets move through the fuser area 43 and to the discharge rollers 46.

The position of the media sheets along the media path 40 is tracked by the controller 20 using one or more of the sensors S1, S2, motors 25, 23, and encoders 26, 24. After the media sheet passes through the second transfer area 91, the leading edge trips sensor S1. At this time, controller 20 registers the position of the media sheet. As the media sheet continues to move along the media path 40, incremental positions are calculated by monitoring the feedback from the encoder 26 to determine the distance the sheet has moved since being detected by the sensor S1. Controller 20 continues to track the media sheet in this manner until the leading edge of the media sheet moves through the fuser nip 43 and trips sensor S2. At this time, controller 20 again registers the position of the leading edge of the media sheet. Continued movement of the media sheet may be obtained by monitoring feedback from one or both encoders 26, 24. After the trailing edge of the media sheet passes beyond sensor S1, the incremental position may then be determined exclusively by monitoring the feedback from encoder 24. In another embodiment, the incremental location is determined by monitoring the number of steps taken by one of the motors 25, 23 since the media sheet has last moved through a sensor S1, S2. One embodiment of monitoring the movement of the media sheets along the media path is disclosed in U.S. Pat. No. 6,330,424, assigned to Lexmark International, Inc., and herein incorporated by reference.

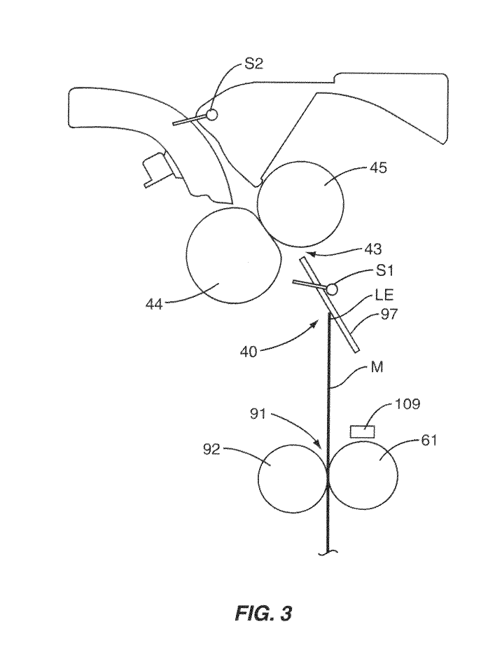

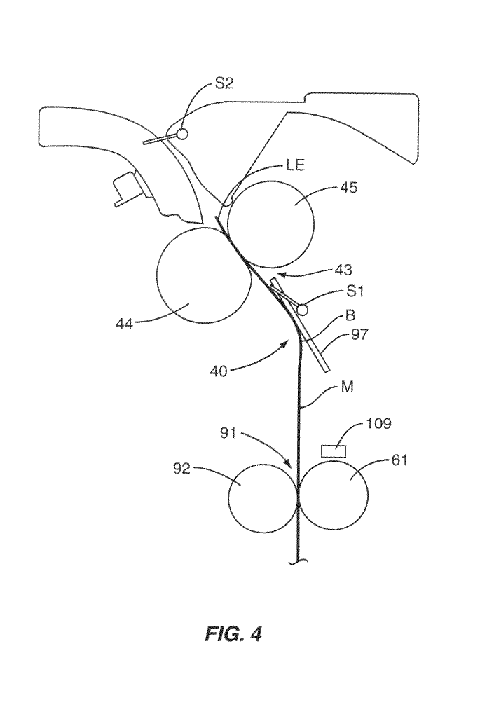

FIGS. 3-7 illustrate one embodiment of controlling the movement of a media sheet M along the media path 40. FIG. 3 illustrates the media sheet moving through the second transfer nip 91. The nip 91 is controlled to move the media sheet M at the proper speed to ensure good toner transfer from the ITM 60. The nip 91 further moves the leading edge LE of the media sheet into a bumper 97 that further directs the leading edge LE towards the transfer nip 43. As illustrated in FIG. 4, the media sheet M is also driven by the nip 91 past sensor S1. The leading edge LE causes the sensor S1 to activate by pivoting away from the media path 40. Activation of the sensor S1 sends a signal to the controller 20 indicating the location of the leading edge LE.

The media sheet M is moved further along the media path 40 as illustrated in FIG. 4. The leading edge moves into the transfer nip 43 and the sheet is concurrently driven by both nips 91, 43. In the embodiment of FIG. 4, the second transfer nip 91 moves the media sheet M at a greater speed than fuser nip 43. As illustrated in FIG. 4, the media sheet M forms a slackened area B. The slackened area B is formed where the media sheet M is pushed against the bumper 97. The controller 20 sets the speeds of the nips 91, 43 to prevent the area B from becoming excessive or being eliminated. An excessive amount of slack may inhibit movement of the media sheet M as it moves out of the second transfer nip 91. This may slow the speed of the media sheet M as it moves through the nip 91. An excessive area B may also cause the media sheet M to contact a cleaner unit 109 that removes waste toner from the ITM 60, This contact may inadvertently transfer waste toner to the media sheet M. Either situation may result in a print defect.

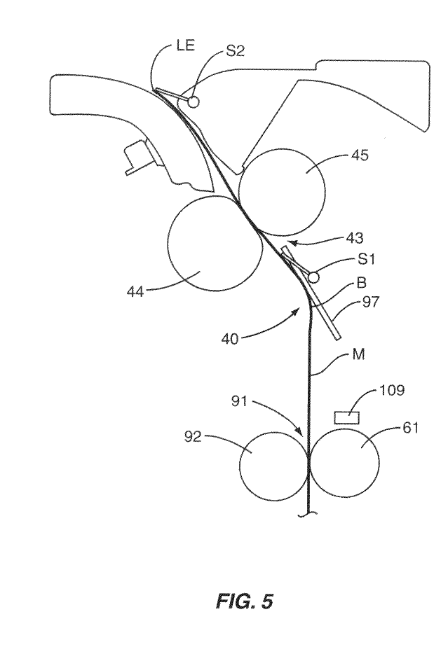

The leading edge LE moves through the fuser nip 43 and actuates sensor S2 as illustrated in FIG. 5. At the time of actuation of sensor S2 the speeds of the nips 91, 43 are set to maintain the slackened area B between the nips 91, 43.

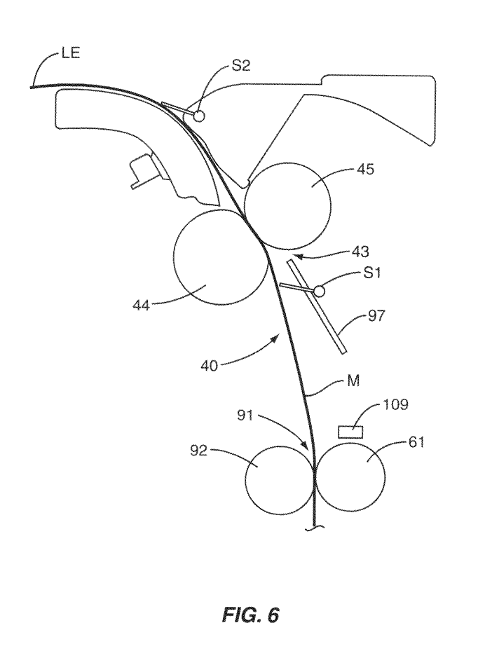

When the leading edge LE actuates sensor S2, controller 20 increases the speed of the fuser nip 43. As illustrated in FIG. 6, the increase in speed reduces or eliminates the slackened area in the media sheet M. This causes the media sheet M to move away from sensor S1 because the media sheet M moves more directly from second transfer nip 91 into the fuser nip 43. The reduction in the size of the slackened area is detected by the controller 20 when it receives a signal from sensor S1 as the media sheet M moves away from the bumper 97 and the sensor S1 is no longer actuated.

Controller 20 further prevents the media sheet M from being pulled at an excessive speed by the fuser nip 43 to cause print defects at the second transfer nip 91. Therefore, controller 20 may slow the speed of the fuser nip 43 after the sensor S1 moves to the non-actuated position. This reduction in speed again causes the slackened area B to reform. Formation of the slackened area B above a predetermined amount again activates the sensor S1. Reforming and dissipation of the slackened area B may continue as the media sheet M moves through the nips 91, 43, Controller 20 may continue to vary the speed of the fuser nip 43 as long as the media sheet M remains along the media path 40. In one embodiment, the controller 20 maintains the increased speed of the fuser nip 43 until the trailing edge TE moves beyond the second sensor S2.

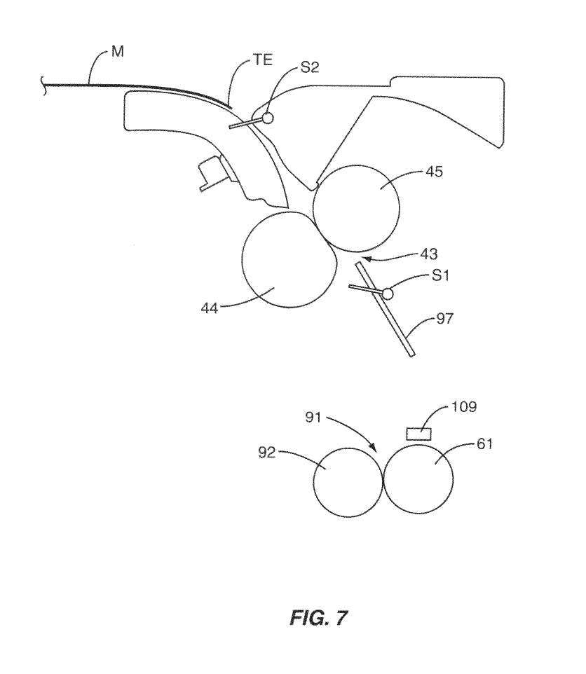

Eventually, the trailing edge TE moves beyond the sensor S2 as illustrated in FIG. 7. Controller 20 determines that the media sheet M has moved beyond the sensor S2 when the sensor S2 returns to the non-actuated position.

In another embodiment, the leading edge LE is moved from the second transfer nip 91 into the fuser nip 43 without activating the sensor S1. The speed of the fuser nip 43 is maintained to prevent the media sheet M from buckling and activating the sensor S1. While the media sheet M is within the fuser nip 43, the speed of the fuser nip 43 may be slowed therefore causing a buckle B to form that eventually activates the sensor S1. The speed of the fuser nip 43 may then be selectively changed between speeds to decrease or eliminate the buckle B, and then let the buckle B reform.

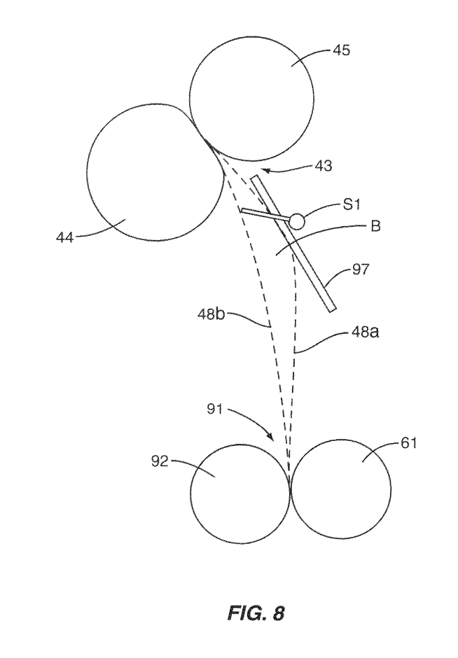

The embodiment described above includes first and second sensors S1, S2 positioned along the media path M. In another embodiment, a single sensor S1 is positioned along the media path 40 as illustrated in FIG. 8. Sensor S1 is positioned to be actuated when a slackened area B is formed by the media sheet M moving along the path indicated by dashed line 48a. When the speed of the fuser nip 43 is increased, the media sheet M is pulled more directly into the fuser nip 43 along a path indicated by dashed line 48b. The size of the slackened area B may vary as the path of the media sheet M fluctuates between lines 48a and 48b.

Controller 20 determines the position of the media sheet based upon the initial actuation of the sensor S1, and tracking the speeds of the nips 91, 43. The leading edge LE is initially determined upon the actuation of sensor S1. The incremental position of the leading edge LE is determined by tracking the speed of the nips 91, 43. After the controller 20 has determined that the media sheet M is within the fuser nip 43, the speed of the fuser nip 43 may be increased. The speed and extent of time is determined by tracking the activation of the sensor S1. Adjustments to the speed of the fuser nip 43 may continue as the media sheet M moves along the path 40.

In one embodiment, controller 20 maintains the speed of the second transfer nip 91 at a relatively constant speed. The speed of the fuser nip 43 is adjusted to prevent the media sheet from being pulled or hindered during the movement which may cause a print defect in other embodiments, controller 20 may vary the speed of the second transfer nip 91 as the media sheet M is within the nip 91.

In the embodiments described above, the sensor S1 is actuated when contacted by the media sheet M, and deactivated when the media sheet M moves away. In other embodiments, sensor S1 may be actuated when the sheet M moves away, and deactivated during contact with the sheet M.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description

As used herein, the terms “having”, “containing”, “including”, “comprising” and the like are open ended terms that indicate the presence of stated elements or features, but do not preclude additional elements or features, The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of moving a media sheet within an image forming device, the method comprising the steps of:
moving the media sheet along a media path;
forming a slackened area in the media sheet while the media sheet is between first and second sections of the media path;
moving the media sheet between the first and second sections and activating a sensor;
after activating the sensor, increasing a speed of the second section of the media path and reducing a size of the slackened area; and
reducing the size of the slackened area and deactivating the sensor.

2. The method of claim 1, further comprising receiving a toner image from an intermediate member while moving the media sheet through the first section.

3. The method of claim 1, further comprising fusing a toner image to the media sheet while moving the media sheet through the second section.

4. The method of claim 1, further comprising activating the sensor positioned between the first and second sections when the slackened area reaches a predetermined size.

5. The method of claim 1, further comprising maintaining the media sheet moving through the first section at a substantially constant speed while reducing the size of the slackened area.

6. The method of claim 1, further comprising moving the media sheet past a second sensor locating downstream from the second section prior to reducing the size of the slackened area.

7. The method of claim 1, wherein the step of activating the sensor occurs after a leading edge of the media sheet has moved into the second section.

8. The method of claim 1, further comprising after performing the step of reducing the size of the slackened area and deactivating the sensor, slowing the speed of the second section, reforming the slackened area in the media sheet, and reactivating the sensor.

9. A method of moving a media sheet within an image forming device, the method comprising the steps of:
moving the media sheet along a media path and positioning the media sheet simultaneously within a first nip and a second nip that is positioned downstream from the first nip;
moving the media sheet at a first speed through the first nip and a second lower speed through the second nip;
forming a slackened area in the media sheet between the first and second nips while the media sheet is in contact with the first and second nips;
activating a sensor with the slackened area, the sensor being positioned along the media path between the first and second nips;
after activating the sensor, increasing the second nip to a third speed that is faster than the first speed and reducing the slackened area; and
while moving the media sheet through the second nip at the third speed, reducing the slackened area and deactivating the sensor.

10. The method of claim 9, further comprising preventing the media sheet from being in tension while moving through the first nip.

11. The method of claim 9, further comprising activating the sensor when the slackened area reaches a predetermined size.

12. The method of claim 9, further comprising directing the media sheet into a bumper prior to moving the media sheet into the second nip.

13. The method of claim 9, wherein the step of moving the media sheet at the second lower speed through the second nip occurs after a section of the media sheet moves through the second nip.

14. The method of claim 13, further comprising continuing to operate the second nip at the third speed until a trailing edge of the media sheet moves past the second sensor.

15. The method of claim 9, further comprising transferring a toner image to the media sheet while moving through the first nip and fusing the toner image to the media sheet while moving the media sheet through the second nip.

16. A method of moving a media sheet within an image forming device, the method comprising the steps of:
moving the media sheet through a toner transfer nip and receiving a toner image;
moving a leading edge of the media sheet past a sensor positioned along the media path downstream from the toner transfer nip and activating the sensor;
moving the leading edge of the media sheet into a fuser nip positioned along the media path downstream from the sensor;
forming a slackened area in the media sheet while the media sheet is simultaneously moving through the toner transfer and fuser nips;
increasing a speed of the fuser nip while the media sheet is within the toner transfer and fuser nips;
reducing a size of the slackened area; and
deactivating the sensor.

17. The method of claim 16 wherein the step of reducing the size of the slackened area moves the media sheet away from the sensor.

18. The method of claim 16, further comprising maintaining a speed of the media sheet moving through the toner transfer nip while increasing the speed of the fuser nip.

19. The method of claim 16 further comprising after performing the step of reducing the size of the slackened area decreasing the speed of the fuser nip and reactivating the sensor.

20. The method of claim 16 further comprising moving the leading edge of the media sheet past a second sensor positioned downstream from the fuser nip prior to increasing the speed of the fuser nip.

21. The method of claim 16, further comprising directing the leading edge of the media sheet into a bumper prior to moving the leading edge into the fuser nip.
